(19) United States
(12) Patent Application Publication
(10) Pub. No.: US 2019/0381378 A1
(43) Pub. Date: Dec. 19, 2019

(54) GLOW GOAL

(71) Applicant: Brian Pierre, Magnolia, MS (US)

(72) Inventor: Brian Pierre, Magnolia, MS (US)

(21) Appl. No.: 16/503,408

(22) Filed: Jul. 3, 2019

Related U.S. Application Data
(60) Provisional application No. 62/762,408, filed on May 4, 2018.

(51) Int. Cl. A63B 63/08; A63B 71/06; A63B 71/02; F21S 9/03; H04R 1/02

(52) U.S. Cl. CPC A63B 63/083; A63B 71/0622; A63B 71/023; F21S 9/032; H04R 1/028; H04R 2420/07; A63B 2207/02; A63B 2071/0625; A63B 2225/50; A63B 2071/025; H04R 1/023

(57) ABSTRACT

An improved lighted basketball goal is provided having a backboard base having a lighting strip, comprising LED lights, mounted to the edges of the backboard base. The lighting strip is disposed around the periphery of a translucent backboard, which is mounted to the backboard base and supported by a pedestal. The pedestal is supported by a lower base unit having wheels disposed on at least one side. At least one iron angle blinder is mounted to the translucent backboard to protect a basketball player's eyes from glare when making a layup. A solar panel is mounted to the opposing side of the backboard base to provide electrical power to a rechargeable battery disposed within the pedestal. The rechargeable battery powers the lighting strip and a Bluetooth speaker system embedded within the pedestal.

### CROSS REFERENCE TO RELATED APPLICATIONS

The application claims the benefit of U.S. Provisional Application No. 62/762,408, filed on May 4, 2018, which is incorporated herein by reference.

### BACKGROUND OF THE INVENTION

### Field of the Invention

The present invention generally relates to the general art of recreational equipment and more particularly to basketball equipment.

### Description of the Related Art

Basketball games are invariably played in a lighted environment. Lighting is necessary because a person must be able to see the hoop and or basket in order to hit it with a ball. Consequently, a lighted court, whether indoors or outdoors, is required for games played after dark. Because of the widespread availability of lighted courts, the same hoops and backboards can be used whether the courts are indoors or outdoors and whether the hoops and backboards are used during the day or after dark. As a result, players and spectators usually pay no attention to the hoops and backboards other than to recognize their existence.

The game of basketball is a well-known and popular sport played by individuals of all ages and skill levels. Due to its appeal, many homeowners install a basketball goal adjacent to their driveway or on a paved surface. A basketball goal normally includes a vertically disposed backboard and a rim (or hoop) extending therefrom, into which a basketball is thrown. The goal is usually supported by a pole a distance above the ground. In other instances, the goal extends from, and is secured to, the end or side of a building, such as a garage.

Many individuals who own basketball goals attempt to play the game at night by the light of street lamps and the exterior lighting of homes. These lights rarely provide sufficient lighting for a number of reasons. First, outdoor lighting, such as street lighting or an outdoor spotlight, is usually not bright enough to fully illuminate the basketball goal. Second, it is usually not specifically positioned to illuminate the basketball goal in a way that will minimize shadows. Third, outdoor lighting systems produce a concentrated light that may make it harder to see a basketball rim when the light source is behind the backstop or backboard.

As the game of basketball continues to increase in popularity, a large number of people have purchased basketball systems for use at their homes. Such basketball systems typically include a support pole, which is held in a fixed position while playing the game of basketball, and goal assembly that is attached to the upper portion of the support pole. The goal assembly, which is suspended a given distance above a playing surface, typically includes a basketball backboard frame, a basketball backboard, and goal or rim. Conventional basketball systems designed for use at home often include basketball backboard frames that are constructed from metal or steel and include a number of individual sections that are joined together. The metal frame is typically attached to the support pole by a support structure that includes two or more elongated arms. The basketball backboard, which may also be referred to as a rebound member or basketball backboard panel, is often attached to the metal support frame by one or more screws or bolts.

Basketball backboards for use with home basketball systems have previously been constructed from solid materials such as wood. Disadvantageously, wooden basketball backboards deteriorate over time, especially when used in outdoor environments because the backboards are constantly exposed to harsh weather environments such as rain and snow. Basketball backboards for home basketball systems have also be constructed from injection molded plastic. Injection molded plastic backboards, however, are relatively flexible and that often causes poor rebounding characteristics. In particular, when basketballs strike injection molded plastic backboards, the backboards typically flex and that causes basketballs to bounce off of or rebound in inconsistent and unpredictable manners. In addition, different portions of injection molded plastic backboards may flex or bend different amounts. For example, portions of injection molded plastic backboards that are supported by a frame may flex or bend significantly less than portions of the backboard that are not supported by the frame. Accordingly, basketballs may rebound differently depending upon which portion of the backboard it strikes.

Conventional injection molded plastic backboards typically require strengthening ribs and other complex structures in an attempt to strengthen the backboards. These strengthening ribs and other structures, however, disadvantageously increase the weight and cost of the backboard. Additionally, known basketball backboards may be constructed using a structural foam material with an internal cellular structure and a hard external shell. Undesirably, this type of backboard typically requires a multiple step manufacturing process that increases the time and cost to manufacture the backboard.

One feature of home basketball systems that is becoming more popular is the use of transparent or clear backboards so that the backboards resemble those used in professional and collegiate games. In particular, most professional leagues and major colleges use tempered glass backboards to allow spectators to view the game through the backboard. Tempered glass backboards are generally one-half (½) to three-eights (⅜) of an inch thick and the tempered glass is very heavy. Thus, a large support frame, support structure and support pole are required to position the glass backboard above the playing surface. In addition, tempered glass backboards are also very expensive and the glass can be undesirably scratched, damaged and/or broken. In order to create a look similar to the tempered glass backboards used in professional and college games, transparent or clear backboards are now being used in connection with home basketball systems. For example, known home basketball systems may use a metal basketball backboard frame and backboard consisting of a planar acrylic sheet that is attached to the front surface of the metal frame. Disadvantageously, the outer edges of the acrylic backboard are often exposed and not supported by the metal frame. This may allow the edges of the backboard to be broken or damaged when struck by a basketball or other objects.

Conventional acrylic basketball backboards are often attached to the backboard frame by one or more fasteners such as screws or bolts. Disadvantageously, the openings in the acrylic sheet for the screws or bolts may create stress points or concentrations that reduce the strength and/or structural integrity of the backboard. The acrylic basketball backboards may also be attached to a frame by double-sided adhesive tape. The double-sided adhesive tape must securely bond the backboard to the frame. The double-sided tape must also allow impact energy from the basketball striking the backboard to be transferred to the frame, and the tape must have sufficient flexibility to dissipate the impact energy from the backboard to the frame. If the attachment of the basketball backboard to the frame is too rigid, then the backboard can fracture. On the other hand, if the attachment of the basketball backboard to the frame is too loose, then the backboard may dislodge or separate from the frame and it may fall to the playing surface.

It is also known to use acrylic basketball backboards in connection with basketball backboard frames constructed from injection molded plastic. Conventional injection molded plastic frames may include separately molded front and rear sections that are connected together to form the frame. In particular, the front and rear sections of the frame may include alignment features that allow the sections to be attached in the desired manner and a slot or opening is disposed between the front and rear sections. The acrylic basketball backboard is inserted into the slot to form the basketball goal assembly. The injection molded plastic frame typically requires structural foam or fiberglass-reinforced plastic to provide the required strength to support the acrylic basketball backboard and provide the proper rebound performance.

Disadvantageously, conventional acrylic basketball backboards may crack, break, fracture and/or shatter if subjected to very large impacts or forces. In order to help prevent the acrylic basketball backboards from undesirably breaking, various types of modifiers have been added to the acrylic. In addition, the inks used to apply graphics to the acrylic backboard and the lights used to cure the backboard have been changed in various attempts to prevent the backboards from breaking. The acrylic backboards, however, may still break if subjected to very large impacts or forces. The processes used to attach the acrylic backboard to the frame have also been modified in order to help prevent the backboards from breaking. For example, different types of adhesives and bonding processes have been used to attach the acrylic backboard to the frame. Conventional acrylic backboards, however, may still undesirably break if excessive forces are applied to the backboard.

In order to increase the strength of conventional acrylic basketball backboards, the thickness of the acrylic may be increased. Undesirably, this increases the costs and weight of the backboards. In addition, a larger and more complex backboard frame and support structure may be required to support the heavier basketball backboard, which may further increase the cost of the basketball goal system.

Additionally, known basketball backboards constructed from acrylic or other types of plastic often deteriorate over time. In particular, conventional plastic backboards may deteriorate over time because of exposure to sunlight. The sunlight may cause the plastic backboards to discolor or become brittle over a period of time such as four to five years, and these effects may be even more pronounced after five to six years. In addition, environmental conditions such as temperature and moisture may degrade the acrylic and other types of plastics conventionally used to construct basketball backboards. Disadvantageously, the brittle plastic backboards are more likely to break or fracture. In addition, the discoloration of the backboard may change the appearance of the basketball system and may be aesthetically unpleasing.

While these units may be suitable for the particular purpose employed, they would not be as suitable for the purposes of the present invention as disclosed hereafter.

Accordingly, there is a need for a basketball backboard that eliminates or reduces some or all of the above-described disadvantages and problems.

As disclosed in this application, the inventor has discovered novel and unique devices for lighted basketball backboard systems, with increased visibility and portability, providing more predictable rebound effects, having sounds effects, and providing use in a dark environment.

Embodiments of the present invention provide for devices and disclosed herein and as defined in the annexed claims which provide for improved basketball backboard systems.

### SUMMARY OF THE INVENTION

It is one prospect of the present invention to provide one or more novel devices of simple but effective construction which can be applied and used in many environments with increased visibility and portability while also providing music and sounds effects.

Another prospect of the present invention is to provide an improved lighted basketball backboard system having blinders and reflectors protecting a user's eyes against glare, providing for more efficient and effective use in a dark environment.

The following presents a simplified summary of the present disclosure in a simplified form as a prelude to the more detailed description that is presented herein.

Therefore, in accordance with embodiments of the invention, there is provided a basketball goal having a pedestal supported upright by a lower base unit, and the lower base unit has wheels disposed on at least one side of the lower base unit. The basketball goal includes a backboard base mounted atop the pedestal. The backboard base has a front surface opposite a rear surface.

In one embodiment, the basketball goal includes a translucent backboard mounted to the front surface of the backboard base as well as a basket mounted to the front surface of the backboard base. Preferably, the basketball goal includes a lighting strip disposed along an outer edge of the front surface of the backboard base.

In a preferred embodiment, the basketball goal includes at least one angle iron blinder, which is opaque to the passage of light, disposed along a front outer edge of the translucent backboard. In yet another preferred embodiment, the basketball goal has at least two opposing angle iron blinders, and each angle iron blinder is fixed to a front surface of the translucent backboard and disposed along an outer side edge of the translucent backboard. Each angle iron blinder preferably comprises an interior reflective surface facing the basket, and the interior reflective surface adapted to direct light emitted from the lighting strip to the basket. The lighting strip preferably includes light emitting diodes (LEDs).

In another embodiment, the basketball goal has a weather resistant Bluetooth speaker system embedded within the pedestal, a solar panel mounted to a rear surface of the backboard base, and a rechargeable battery unit disposed within the pedestal. The rechargeable battery unit is electrically connected to the lighting strip, the Bluetooth speaker system, and the solar panel for powering said lights and Bluetooth speaker system, at the option of a user.

In yet another embodiment, the basketball goal further comprises a black opaque insert mounted onto a rear surface of the translucent backboard. In such manner, the goal has a clear backboard while the rear of the goal has a black backboard.

In another embodiment, the basketball goal further includes a screen cover mounted to the pedestal, said screen cover crossing a front surface of the Bluetooth speaker system.

In one embodiment, the basketball goal includes a cage mounted to the rear surface of the backboard base, and the cage is disposed around the solar panel.

In accordance with embodiments disclosed herein, viewing the goal from the front, the LED lighting is preferably positioned around the goal, lights are located in between the backboard, and angle iron blinders for the LED lighting protect a person's eyes while shooting. Preferably, with respect to the rear of the goal, there is preferably a solar panel for solar power, and a back cage that protects the solar power panel. Preferably, there is also a waterproof Bluetooth speaker system built into the pedestal. The battery pack for the solar power panel, which is used to power the LED lighting and the Bluetooth speaker system, is preferably disposed on the back of the pedestal of the basketball goal. The goal also includes wheels which allow the goal to be easily moved.

Viewing the goal from the side shows the LED lighting with the angle iron blinders that protect a person's eyes while shooting, the panel for solar power, the back cage that protects the panel for solar power, the waterproof Bluetooth speaker system and the battery pack used to power the LED lighting and the Bluetooth speaker system.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a front elevation view of an exemplary embodiment of a basketball goal, in accordance with embodiments of the present invention; and

FIG. 2 is a side elevation view thereof.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

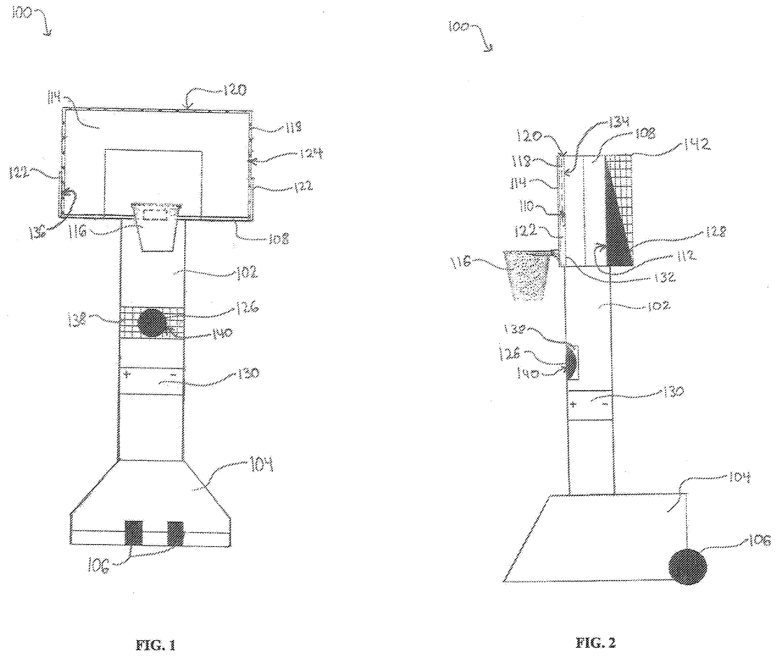

Referring to FIGS. 1-2, the basic constructional details and principles of operation of embodiments of a basketball goal 100 according to embodiments of the present invention will be discussed.

As shown in FIG. 1, in a preferred embodiment, the basketball goal 100 has a pedestal 102 supported upright by a lower base unit 104 having wheels 106 disposed on at least one side of the lower base unit 104 adapted to permit easy movement of the basketball goal 100. Preferably, a backboard base 108 is mounted atop the pedestal 102. The backboard base 108 has a front surface 110 opposite a rear surface 112. In such preferred embodiment, a translucent backboard 114 is mounted to the front surface 110 of the backboard base 108. A basket 116 is mounted to the front surface 110 of the backboard base 108. The basketball goal 100 has a lighting strip 118, which preferably contains light emitting diodes (LED) lights, disposed along an outer edge 120 of the front surface 110 of the backboard base 108. In such preferred embodiment, the basketball goal 100 preferably includes at least one angle iron blinder 122 opaque to the passage of light disposed along an outer edge 124 of the translucent backboard 114, to direct light in a manner which illuminates the basket 116 while preventing light from shining into a user's eyes.

In one embodiment, a weather resistant Bluetooth speaker system 126 is embedded within the pedestal 102. As such, the basketball goal 100 can play music and sound effects signaled by a user's personal digital assistant (PDA), such as a user's cell phone, while in relative proximity to the basketball goal 100, such as while playing basketball, at the option of the user.

As illustrated in FIG. 2, a solar panel 128 is preferably mounted to the rear surface 112 of the backboard base 108. Preferably, as shown in FIGS. 1-2, a rechargeable battery unit 130 is disposed within the pedestal 102. The rechargeable battery unit 130 is electrically connected to the lighting strip 118, the Bluetooth speaker system 126, and the solar panel 128 for powering of the lighting strip 118 and the Bluetooth speaker system 126, at the option of the user. The solar panel 128 is adapted to provide electrical power to charge the rechargeable battery unit 130.

In one embodiment, the basketball goal 100 has a black opaque insert 132, which is adapted to enhance visibility of a user, and the black opaque insert 132 is preferably mounted on a rear surface 134 of the translucent backboard 114, as illustrated in FIG. 2.

In another embodiment, the basketball goal 100 has at least a second angle iron blinder 122 opaque to the passage of light disposed along the outer edge 124 of the translucent backboard 114.

In yet another embodiment, each angle iron blinder 122 of the basketball goal 100 has an interior reflective surface 136 facing the basket 116, and the interior reflective surface 136 is preferably configured to direct light emitted from the lighting strip 118 in the direction of the basket 116; and though such embodiments of the invention, each angle iron blinder 122 is adapted to protect a user's eyes when the user is making a layup, for example.

In one embodiment, shown in FIG. 1, the basketball goal 100 has a screen cover 138 mounted to the pedestal 102 crossing a front surface 140 of the Bluetooth speaker system 126, to protect the Bluetooth speaker system 126 from damage while the user is playing basketball.

In another embodiment, as illustrated in FIG. 2, the basketball goal 100 has a cage 142 mounted to the rear surface 114 of the backboard base 108, where the cage 142 is disposed around the solar panel 128. The cage 142 is adapted to protect the solar panel 128 from damage.

In yet another embodiment, as shown in FIGS. 1-2, the lower base unit 104 of the basketball goal 100 has wheels 106 disposed on at least one side of the lower base unit 104. In a preferred embodiment, the lower base unit 104 of the basketball goal 100 has wheels 106 on opposing sides of the lower base unit 104.

It is understood that while certain forms of the present invention have been illustrated and described herein, it is not to be limited to the specific forms or arrangements of parts described and shown.

All U.S. patents and publications identified herein are incorporated in their entirety by reference thereto.

The claimed invention is:

1. A basketball goal comprising:
a pedestal supported upright by a lower base unit having wheels disposed on at least one side of the lower base unit;
a backboard base mounted atop the pedestal, said backboard base having a front surface opposite a rear surface;
a translucent backboard mounted to the front surface of the backboard base;
a basket mounted to the front surface of the backboard base;
a lighting strip disposed along an outer edge of the front surface of the backboard base;
at least one angle iron blinder opaque to the passage of light fixed to a front surface of the translucent backboard and disposed along an outer edge of the translucent backboard;
a weather resistant Bluetooth speaker system embedded within the pedestal;
a solar panel mounted to a rear surface of the backboard base; and
a rechargeable battery unit disposed within the pedestal wherein said rechargeable battery unit is electrically connected to the lighting strip, the Bluetooth speaker system, and the solar panel for powering said lights and Bluetooth speaker system, at the option of a user.

2. The basketball goal of claim 1, further comprising a black opaque insert mounted on a rear surface of the translucent backboard.

3. The basketball goal of claim 1, further comprising at least a second angle iron blinder opaque to the passage of light disposed along the outer edge of the translucent backboard.

4. The basketball goal of claim 1, wherein each angle iron blinder comprises an interior reflective surface facing the basket, the interior reflective surface adapted to direct light emitted from the lighting strip to the basket.

5. The basketball goal of claim 4, wherein the lighting strip comprises light emitting diodes (LEDs).

6. The basketball goal of claim 1, further comprising a screen cover mounted to the pedestal, said screen cover crossing a front surface of the Bluetooth speaker system.

7. The basketball goal of claim 1, further comprising a cage mounted to the rear surface of the backboard base, wherein said cage is disposed around the solar panel.

8. The basketball goal of claim 1, wherein the lower base unit comprises a plurality of wheels disposed on at least two opposing sides of the lower base unit.
